(19) United States
(12) Patent Application Publication
(10) Pub. No.: US 2016/0161040 A1
(43) Pub. Date: Jun. 9, 2016

(54) HEATABLE ARTICLE, IN PARTICULAR A HEATABLE HOSE HAVING A PLASTIC-SHEATHED HEATING ELEMENT, AND METHOD FOR THE PRODUCTION THEREOF

(71) Applicant: CONTITECH SCHLAUGH GMBH, Hannover (DE)

(72) Inventors: Rainer Lange, Frankenau (DE); Metin Tasseki, Korbach (DE)

(21) Appl. No.: 14/906,733

(22) PCT Filed: Apr. 17, 2014
(86) PCT No.: PCT/EP2014/057844

§ 371 Date: Jan. 21, 2016

(30) Foreign Application Priority Data
Jul. 24, 2013 (DE) 10 2013 107 917.2

(51) Int. Cl. F16L 53/00; B32B 25/08; B32B 15/08; H05B 3/00; B32B 1/08

(52) U.S. Cl. CPC F16L 53/008; H05B 3/00; B32B 1/08; B32B 15/08; B32B 25/08; B32B 2274/00; B32B 2307/206; B32B 2307/306; B32B 2307/734; B32B 2597/00

(57) ABSTRACT

The invention relates to a heatable article, in particular a heatable hose (8), having an elastic main body made of a vulcanisate, a heating element (12) being embedded in the main body, said heating element being electrically connectible to an electrical terminal connection and comprising a core as a heating wire and a sheath made of an electrically insulating polymer material. The sheath is made of at least one tempered thermoplastic elastomer, in particular TPC. The invention also relates to a method for producing a heatable article, in particular a heatable hose (12).

### CROSS REFERENCE TO RELATED APPLICATIONS

This application is a continuation application of international patent application PCT/EP2014/057844, filed Apr. 17, 2014, designating the United States and claiming priority from German application 10 2013 107 917.2, filed Jul. 24, 2013, and the entire content of both applications is incorporated herein by reference.

### FIELD OF THE INVENTION

The invention relates to a heatable product with a resilient main body made of a vulcanizate, where embedded into the main body there is a heating conductor which can be connected electrically to an electrical connection device.

### BACKGROUND OF THE INVENTION

Jackets of heating conductors are disclosed in EP EP2214176A1 which use polyphenylenes, where these have electrically insulating properties and are stable under vulcanization conditions. However, use of polyphenylenes has been found to be disadvantageous. Pure PPS is much too hard and brittle, and expensive. Resultant problems relate inter alia to dimensional stability and to processability.

As such, there exists an ongoing need for development of jackets for heating conductors with improved properties, such need met, at least in part, by embodiments according to the following disclosure.

### SUMMARY OF THE INVENTION

The invention relates to a heatable product with a resilient main body made of a vulcanizate, where embedded into the main body there is a heating conductor which can be connected electrically to an electrical connection device, and which comprises a core in the form of heating wire and a jacket made of an electrically insulating polymeric material. Embedded into the product there is mostly also reinforcement, which can be of single- or multiple-ply design. The invention further relates to a process for the production of this type of heatable product.

A product of the abovementioned type is in particular used as a heatable hose. In order that a fluid flowing in the hose can be heated, said hose has a heating conductor which extends over at least a portion of the length of the hose, and specifically in particular takes the form of a helix. The heating conductor comprises a metallic core and a jacket in the form of insulating layer. The heating conductor here has been embedded within the external layer of the hose, in particular immediately above the braid-type reinforcement layer. It is important that in the region of the electrical connection device it is possible to render the heating conductor accessible without damage to the metallic core thereof and the jacket thereof.

The object of the present invention therefore consists in providing, for the jacket of the heating conductor, a polymeric material with insulating properties which firstly can be used as alternative to polyphenylene and secondly features improved dimensional stability and processability. The intention here is at the same time to provide good resistance to pressure at high temperature, and thus a low wastage rate.

Good resistance to pressure at high temperature is moreover necessary because, during the process of vulcanization of the preform of the product, heat and/or pressure, in particular in the region of contact of insulation and the braid-type reinforcement layer, cause(s) major local reduction of the thickness of, or even destruction of, the insulation layer. Replicated braid patterns are produced in the insulation layer. In particular at these locations the insulation splits when the heating conductor is drawn out from the vulcanizate layer. A consequence of this is that, in particular in the case of hoses, a not inconsiderable proportion of the product has often had to be discarded as waste.

Said object is achieved in that the jacket is composed of at least one heat-conditioned thermoplastic elastomer.

According to Rompp-Chemielexikon Online [Römpp's chemical encyclopedia on-line], version 3.33, thermoplastic elastomers (TPEs) are “polymers, another term used being thermoplastic rubbers, which ideally combine the usage properties of elastomers with the processing properties of thermoplastics. This can be achieved if the macromolecules of the appropriate plastics simultaneously comprise soft and resilient segments with high extensibility and low glass transition temperature (Tg) and hard, crystallizable segments with low extensibility, high Tg, and a tendency toward association (physical crosslinking). The soft and hard segments have to be mutually incompatible and have to be present in the form of individual phases. Thermoplastic elastomers are therefore characterized by thermally labile, reversibly cleavable crosslinking sites, the nature of which is mostly physical, but can also be chemical [. . . ].”

In the invention it is possible to use any of the thermoplastic elastomers known to the person skilled in the art, for example TPA, TPC, TPO, TPS, TPU, TPV, and TPZ. The nomenclature here is in accordance with ISO 18064:2003(E). In particular it has proven advantageous to use TPC, i.e. thermoplastic polyester elastomers (another term used for which is thermoplastic copolyesters) having segments made of ether and/or ester.

A feature of TPE-C in particular in comparison with the known polyphenylenes is better dimensional stability due to the partial crosslinking present in TPE-C. The pure or blended polyphenylene used hitherto exhibits markedly poorer dimensional stability. The tensile strain value of TPE-C is moreover also markedly more advantageous for the use in the hose or as jacket of a heating conductor in a hose. The tensile strain value of TPE-C is about 450%, whereas the tensile strain value of polyphenylene, in particular PPS, is only 100%. These properties of the thermoplastic elastomer, preferably the TPE-C, ensure that the heating conductors with this type of jacket are markedly more flexible than those with by way of example PPS, and therefore require less force for processing in relatively small bending radii. All stages of processing therefore become easier, and the proportion of defects and rejected product is thus minimized.

The TPC here can take the form of TPS-EE with soft segments made of ether and ester, of TPC-ES with soft segments made of polyester, or of TEC-ET with soft segments made of polyether. It has proven to be particularly advantageous to use TPC-ES, which by way of example is obtainable with trademark Arnitel® CM551 from DSM Engineering Plastics.

The jacket of the heating conductor in the invention is composed entirely of at least one thermoplastic elastomer. It is therefore also possible to use combinations of various thermoplastic elastomers.

The thermoplastic elastomers of the abovementioned type feature good strength. For full achievement of the object mentioned in the introduction it is necessary that thermoplastic elastomers have been additionally heat-conditioned, i.e. have been heated for a relatively long period. The heat-conditioning increases the stiffness of the heating conductor, because it increases winding tension.

Another object of the invention consists of providing a process for the production of a heatable product, where the jacket of the heating conductor is moreover pressure-resistant at high temperature, and a marked reduction of the wastage rate is achieved, while at the same time the jacket reduces risks associated with the product.

Said object is achieved via at least the following steps:
the jacket of the heating conductor, said jacket being composed of at least one thermoplastic elastomer, is heat-conditioned;
the heat-conditioned heating conductor is embedded into a vulcanizable polymer mixture that forms the main body, thus specifically forming a preform of the product;
finally the preform of the product is vulcanized.

The process of heat-conditioning of the plastics-jacketed heating conductor here is essential, because otherwise the desired and necessary properties of the materials are not obtained.

Heat-conditioning means firstly, in general terms, the heating of a substance or of an article over a relatively long period. It is thus possible to eliminate crystal-structure stresses and cracks produced by high-temperature deformation with subsequent rapid cooling, thus finally achieving stability and improved product quality. The heat-conditioning temperature is frequently close to, but naturally below, the melting point. In the case of plastics this is achieved via storage at increased temperature, the aim being to achieve improved heat resistance, to dissipate internal stresses, and to anticipate subsequent shrinkage. The heat treatment takes place at temperatures that depend on the material and are below the softening range or crystalline melting range. During the period of storage at increased temperature care must be taken that the temperature is as constant as possible, and that there is good air circulation within the convection oven. Stacking of the components on top of one another should moreover be avoided, in order to avoid overheating.

The heating conductors comprising a core in the form of heating wire and a jacket made of an electrically insulating polymeric material are delivered on reels from the producer of these heating conductors and, before incorporation into the heatable product, are subjected to a heat-conditioning process in a drying oven. The treatment temperature and treatment time must be appropriate for the thermoplastic elastomer to be heat-conditioned. When a thermoplastic elastomer is used as jacket, in particular when TPC is used, it has been found that the best result is achieved with heat-conditioning at from 140 to 180° C., in particular at from 150 to 170° C., more particularly at 160° C. The heat-conditioning period is from 4 to 15 hours, depending on the total mass or the number of windings on the delivered reel. After the heat-conditioning process, before the further processing of the heat-conditioned heating conductor it is advantageous to subject same to slow cooling to room temperature, i.e. to what may be called conditioning to room temperature.

The heat-conditioned heating conductor is then embedded into a vulcanizable polymer mixture that forms the main body, and the preform of the product is then vulcanized.

The polymer mixture used is mostly a vulcanizable rubber mixture which comprises at least one rubber component and conventional mixture ingredients. The rubber components here can preferably be selected from the group comprising ethylene-propylene copolymer (EPM), ethylene-propylene-diene copolymer (EPDM), nitrile rubber (NBR), (partially) hydrogenated nitrile rubber (HNBR), fluororubber (FKM), chloroprene rubber (CR), natural or synthetic polyisoprene (NR or IR), styrene-butadiene rubber (SBR), butyl rubber (IIR), bromobutyl rubber (BIIR), chlorobutyl rubber (CIIR), butadiene rubber (BR), chlorinated polyethylene (CM), chlorosulfonated polyethylene (CSM), polyepichloro-hydrin (ECO), ethylene-vinyl acetate rubber (EVA), acrylate rubber (ACM), ethylene-acrylate rubber (AEM), silicone rubber (MQ, VMQ, PVMQ, FVMQ), fluorinated methylsilicone rubber (MFQ), perfluorinated propylene rubber (FFPM), perfluorocarbon rubber (FFKM), and polyurethane (PU).

In particular, the following are particularly advantageous: EPM, EPDM, HNBR, CR, NR, BR, ACM, AEM, or FKM. All of the rubber components mentioned here can be used alone or in a blend.

The conventional mixture ingredients comprise at least one crosslinking agent or one crosslinking agent system (crosslinking agent and accelerator). Other mixture ingredients are mostly also a filler and/or a processing aid, and/or a plasticizer, and/or an aging retarder, and optionally other additional substances (e.g. color pigments). In this regard we refer to the general prior art in rubber mixture technology.

Reinforcement, which may be single-ply or multiple-ply, is mostly embedded into the resilient main body, in particular in the case of hoses. In the case of hoses, the heating conductor in the form of a helix is incorporated into the external layer above the reinforcement.

### BRIEF DESCRIPTION OF THE DRAWINGS

The invention will now be described with reference to the drawings wherein:

FIG. 1 shows the cross section of a heating conductor comprising a core and a jacket;

FIG. 2 shows a hose with embedded textile reinforcement in crosslaid arrangement; and,

FIG. 3 shows a hose with an embedded heating conductor which has also been drawn out through the external layer.

### DESCRIPTION OF THE PREFERRED EMBODIMENTS OF THE INVENTION

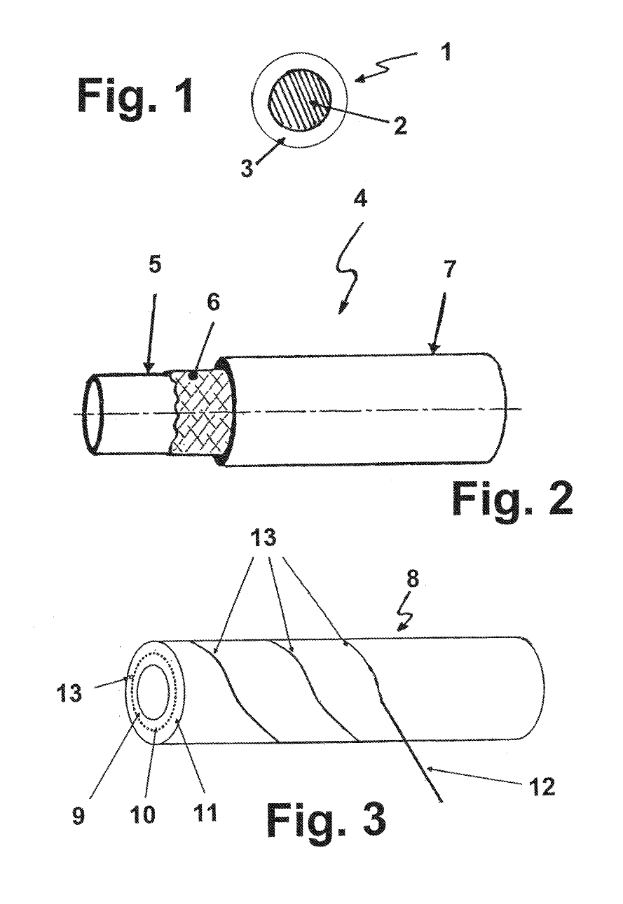

In FIG. 1 the heating conductor 1 comprises a core 2 made of metal in the form of heating wire and a jacket 3 in the form of insulating layer, in particular based on TPC-ES, where the jacket is subjected to heat-conditioning. The heat-conditioned heating conductor is then incorporated into the hose.

In FIG. 2 the hose 4 is composed of an internal layer 5 and external layer 7 made of a vulcanized rubber mixture, based by way of example on EPDM. Between the internal layer and the external layer there is embedded textile reinforcement 6. This reinforcement is by way of example composed of twisted threads, specifically with use of a crosslaid arrangement. This is therefore a reinforcement layer of braided type. The heat-conditioned heating conductor (FIG. 1) has then been incorporated within the external layer 7 and immediately above the reinforcement 6; this structure will now be explained in more detail in conjunction with FIG. 3.

In FIG. 3 the heatable hose 8 comprises an internal layer 9, embedded reinforcement 10, and an external layer 11. The heat-conditioned heating conductor 12 has been incorporated in helical form into the external layer, and can be rendered accessible by means of the separating joint 13, specifically for electrical connection to the electrical connection device.

The heatable hose is in particular used as chemical hose or as pressure hose for motor vehicles, in particular in the truck sector.

It is understood that the foregoing description is that of the preferred embodiments of the invention and that various changes and modifications may be made thereto without departing from the spirit and scope of the invention as defined in the appended claims.

### LIST OF DESIGNATIONS

### Part of description

1 Heating conductor
2 Core of heating conductor
3 Jacket of heating conductor
4 Hose
5 Internal layer
6 Reinforcement
7 External layer
8 Hose
9 Internal layer
10 Reinforcement
11 External layer
12 Heating conductor
13 Separating joint

What is claimed is:

1. A heatable product with a resilient main body made of a vulcanizate, where embedded into the main body there is a heating conductor which can be connected electrically to an electrical connection device, and which comprises a core in the form of heating wire and a jacket made of an electrically insulating polymeric material, wherein the jacket is composed of at least one heat-conditioned thermoplastic elastomer.

2. The heatable product as claimed in claim 1, wherein the jacket is composed entirely of a thermoplastic elastomer.

3. The heatable product as claimed in claim 1, wherein the thermoplastic elastomer is a TPC.

4. The heatable product as claimed in claim 1, wherein the thermoplastic elastomer has been heat-conditioned at from 140 to 180° C.

5. The heatable product as claimed in claim 1, wherein the product is a hose.

6. The heatable product as claimed in claim 5, wherein the product is a chemical hose or a pressure hose for motor vehicles.

7. A process for the production of a heatable product with a resilient main body comprising a vulcanizate, wherein embedded into the main body is a heating conductor electrically connectable to an electrical connection device, and which comprises a core in the form of heating wire and a jacket made of an electrically insulating polymeric material, wherein the process comprises at least the following steps:
providing the jacket of the heating conductor, wherein the jacket is comprised of at least one thermoplastic elastomer and wherein the jacket is heat-conditioned;
embedding the heat-conditioned heating conductor into a vulcanizable polymer mixture that forms the main body, thus forming a preform of the product;
vulcanizing the preform of the product.

8. The process as claimed in claim 7, wherein TPC is used as thermoplastic elastomer.

9. The process as claimed in claim 7, wherein the heat-conditioning of the jacket is carried out at from 140 to 180° C.

10. The process as claimed in claim 7, wherein after the heat-conditioning of the jacket, the heating conductor is slowly cooled to room temperature before further processing.

11. The process as claimed in claim 7, wherein the product is a hose.

12. The process as claimed in claim 11, wherein the product is a chemical hose or a pressure hose for motor vehicles.

13. A method comprising:
providing a heating conductor core electrically connectable to an electrical connection device
disposing a jacket of around the heating conductor core, wherein the jacket is comprised of at least one thermoplastic elastomer and wherein the jacket is heat-conditioned;
embedding the heat-conditioned heating conductor into a vulcanizable polymer mixture that forms the main body, thus forming a preform of a product;
vulcanizing the preform of the product.

14. The method as claimed in claim 13, wherein TPC is used as thermoplastic elastomer.

15. The method as claimed in claim 13, wherein the jacket comprises an electrically insulating polymeric material

16. The method as claimed in claim 13, wherein the heat-conditioning of the jacket is carried out at from 140 to 180° C.

17. The method as claimed in claim 13, wherein after the heat-conditioning of the jacket, the heating conductor is slowly cooled to room temperature before further processing.

18. The method as claimed in claim 13, wherein the product is a hose.

19. The method as claimed in claim 18, wherein the product is a chemical hose or a pressure hose for motor vehicles.

20. The method as claimed in claim 13, wherein the heating conductor core and the jacket are incorporated in helical form into an external layer of the preform of the product.
